(19) United States
(12) Patent Application Publication
(10) Pub. No.: US 2025/0312797 A1
(43) Pub. Date: Oct. 9, 2025

(54) Storage Module for Liquid Handler

(71) Applicant: PARHELIA BIOSCIENCES CORPORATION, Austin, TX (US)

(72) Inventor: Nikolay Samusik, Austin, TX (US)

(21) Appl. No.: 19/169,320

(22) Filed: Apr. 3, 2025

Related U.S. Application Data
(60) Provisional application No. 63/573,533, filed on Apr. 3, 2024.

(51) Int. Cl. B01L 9/06

(52) U.S. Cl. CPC B01L 9/06; B01L 2300/04; B01L 2300/0609; B01L 2300/12

(57) ABSTRACT

A storage module has a base configured to be releasably mounted to the liquid handler. The base has a top and a bottom and vertical side walls extending between the top and bottom. The base has a tube rack with a plurality of rack openings extending through the top of the base. The tube rack supports a plurality of tubes in an upright configuration with open ends of the tubes projecting from the rack openings. A tube rack lid is releasably connectable to the base and has lid openings in register with the rack openings when the tube rack lid is releasably connected with the base. A sealable membrane is disposed between the top of the base and the tube rack lid. The sealable membrane is configured to seal an open end of at least one tube when the at least one tube is received in the tube rack.

### RELATED APPLICATION DATA

This application claims priority benefit to U.S. provisional application Ser. No. 63/573,533, filed Apr. 3, 2024, the disclosure of which is incorporated by reference herein.

### BACKGROUND

The following disclosure is directed to a storage module for a liquid handler. The disclosure is also directed to a sealable membrane that may be used with a storage module for a liquid handler. Methods involving the use of the storage module and sealable membrane are described. A liquid handler including the storage module and sealable membrane are also disclosed.

### DESCRIPTION OF DRAWINGS

FIG. 1 shows an exploded perspective view of an exemplary storage module.

FIG. 2 is a side cross-sectional view of an exemplary storage module.

FIG. 3 is a schematic view of a liquid handler and an exemplary storage module and a control system used in connection therewith.

FIG. 4 is a schematic view of a liquid handler and another embodiment of a storage module shown in cross-section for additional detail of a temperature control system for the storage module

FIG. 5 is a schematic view of a liquid handler and another embodiment of a storage module shown in cross-section for additional detail of an alternate embodiment of a temperature control for the storage module.

FIG. 6 shows a top view of cross section of the exemplary storage module with a sealable membrane extending over the top of a base of the storage module.

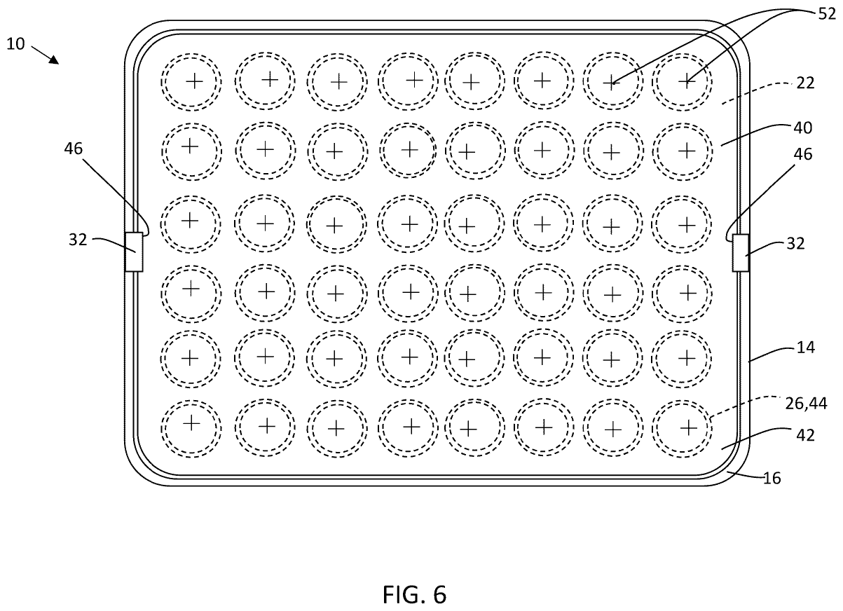

FIG. 7 shows a cross-sectional view of the sealable membrane.

### DETAILED DESCRIPTION

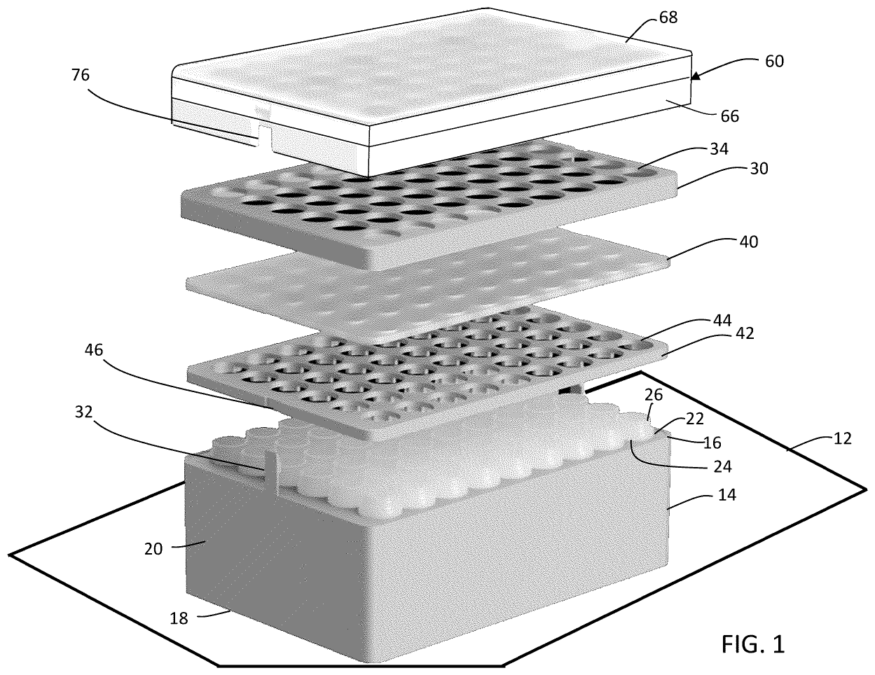

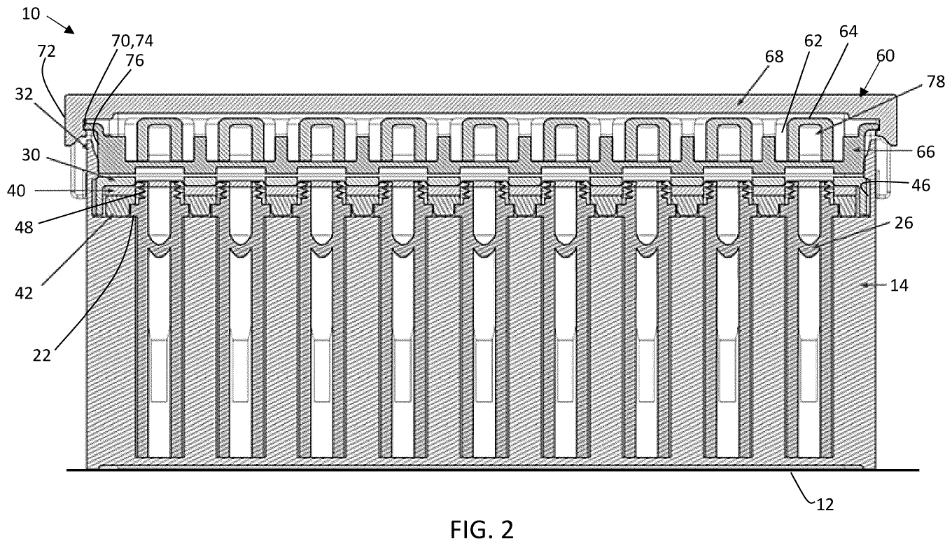

Referring in particular to FIGS. 1 and 2, a storage module 10 for a liquid handler 12 is shown. The storage module 10 may be used with any number of liquid handlers, for instance, liquid handlers provided by Hamilton Company of Reno, Nevada, such as those sold under the brand name Nimbus™, Star™, Star V™ and Vantage™Accordingly, the storage unit 10 may be sold as aftermarket equipment compatible for use with a commercially available liquid handler 12, or the storage unit may incorporated into a liquid handler as original equipment. The storage unit 10 may be one or more storage modules mountable to the liquid handler 12. Further, as will become evident from the discussion that follows, any component part, especially, consumable parts of the storage module, for instance, the sealable membrane, may be provided as needed as a replacement or an aftermarket part. The storage module 10 may be any size and have any capacity as required by the application.

The storage module 10 includes a base 14. The base 14 is adapted and configured to be releasably mounted to the liquid handler 12. The base 14 has a top and a bottom 16,18 and vertical side walls 20 extending between the top and the bottom. The base 14 may have a tube rack 22. The tube rack 22 may be separable from the base 14, integrally formed with the base or may be monolithic with the base. The tube rack 22 may be insertable into and removable from the base 14. The tube rack 22 may comprise a plurality of rack openings 24 positioned at the top 16 of the base 14. The tube rack 22 is adapted and configured to support a plurality of tubes 26 in an upright configuration with open ends of the tubes 26 projecting from the rack openings 24 of the top 16 of the base 14. As shown in the drawings, the tube rack 22 is monolithic with the base 14 so the rack openings 24 of the tube rack lead to vertical shafts formed in the base with portions of the base surrounding and/or supporting the tubes and defining the tube rack. The vertical shafts may terminate at a distance above the bottom 18 of the base 14. The shafts may be sized to receive a tube 26 or vial. The tube rack 22 may also comprise an open structure where the tubes 26 are supported adjacent their open ends by the tube rack 22 at the rack openings 24, but the tube rack 22 may comprise little or no structure of the surrounding the sides of the tubes and may or may not support the bottoms of the tubes 26.

The storage module 10 may further include a tube rack lid 30. In one aspect, the tube rack lid 30 may be connectable to the base 14, and in another aspect, the tube rack lid may be releasably connectable to the base. For instance, the base 14 may have one or more latches 32 that are deflectingly resilient and engage the tube rack lid 30 in releasably connecting the tube rack lid to the base. A tab and groove connection between the tube rack lid and the top of the base may also be provided to releasably connect the tube rack lid to the base. The tube rack lid 30 has lid openings 34 that may be placed in register with the rack openings 24 when the tube rack lid 30 is releasably connected with the base 14 so the open ends of the tube are accessible via the lid openings 34.

The storage module 10 may further include a sealable membrane 40. The sealable membrane 40 is adapted and configured to be disposed between the top 16 of the base 14 and the tube rack lid 30. The sealable membrane 40 extends across the top 16 of the base 14, and as explained below, the sealable membrane is adapted and configured to seal the open end of the tubes 26 when the tubes are received in the tube rack 22.

To further secure the sealable membrane 40 across the top 16 of the base 14 and across the open ends of the tubes 26, the storage module 10 may be provided with a retainer 42. The retainer 42 may be positioned adjacent the top 16 of the base 14 and may be adapted and configured to be disposed between the sealable membrane 40 and the top 16 of the base 14. The retainer 42 may abut the top of the base 14. The retainer 42 may have retainer openings 44 in register with the rack openings 22 and in register with the lid openings 34 when the tube rack lid 30 is releasably connected with the base 14. The retainer 42 may have reliefs 46 on opposite ends of the retainer. The lid retaining latch 32 may fit within the reliefs 46 in a manner to prevent undesirable end to end motion and side to side motion between the retainer and the base 14, and to allow the lid retaining latch to extend vertically upward to engage other component of the storage module 10 that a vertically above the retainer. The retainer 42 may be sized and dimensioned as needed to sandwich the sealable membrane 40 between the retainer 42 and the tube rack lid 30 when the tube rack lid 30 is connected with the base 14. The retainer 42 may be sized and dimensioned to compress the sealable membrane 40 between the retainer and the tube rack lid 30 and/or stretch the sealable member across the open ends of the tubes 26 when the tube rack lid 30 is connected with the base 14. The retainer 42 may also be sized and dimensioned to stretch the sealable membrane 40 in a manner so the sealable membrane engages around sides of the tube 26 adjacent the open end of the tube and across the open end of the tube, when the at least one tube is received in the tube rack 22. To facilitate such side engagement, the sides of the tube 26 adjacent the open end of the tube may be provided with serrations 48 or threading to capture the sealable membrane 40. In the alternative to providing a separate retainer 42 as described above and shown in the drawings, the structure and functionality of the retainer may be formed integral or monolithic with, and project from, the top 16 of the base 14.

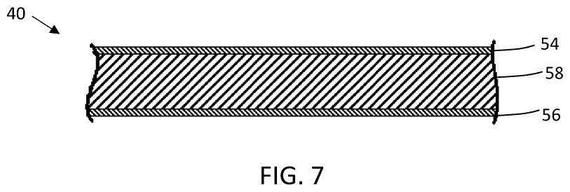

The sealable membrane 40 may be a pliable material that is generally liquid impervious and capable of being penetrated with a pipette 50 of the liquid handler 12. In one example, the sealable membrane 40 has a preformed sealable opening 52 to allow the pipette 50 of the liquid handler to penetrate the membrane. Accordingly, the sealable membrane 40 is comprised of a material that is sufficient to allow a pipette 50 of the liquid handler 12 to enter through the preformed sealable opening 52 and into the tube 26 through the open end of the tube. The material of the sealable membrane 40 is sufficiently pliable and resilient so as to re-seal the preformed sealable opening 52 and the open end of the tube when the pipette of the liquid handler is withdrawn from the preformed sealable opening. In such an example, the sealable membrane 40 may have a preformed sealable opening 52 comprising fold lines to enable the sealable membrane to re-seal the pre-formed opening when the pipette 50 of the liquid handler is withdrawn from the preformed sealable opening. In another example, the sealable membrane 40 comprises a material sufficient to allow a pipette 50 of the liquid handler to pierce the sealable membrane and enter into the tube 26 through the open end tube. The material of the sealable membrane 40 is sufficiently pliable and resilient so as to be self-healing and re-seal the piercing and seal the open end of the tube when the pipette 50 of the liquid handler is withdrawn from the sealable membrane. In such an example, the sealable membrane 40 may be pre-scored and/or have fold lines 52 to enable the pipette 50 to penetrate and enable the sealable membrane to re-seal the piercing. The sealable membrane 40 may be sized and dimensioned accordingly to allow the pipette 50 to penetrate the sealable membrane 40 (whether via a piercing or preformed hole) and to allow the sealable membrane to reseal the open end of the tube. The sealable membrane 40 may be sized and dimensioned accordingly to allow the sealable membrane to stretch and compress and engage the serrations 46 on the side of the tube 26. The sealable membrane 40 may comprise a silicone based material. As shown in FIG. 7, the sealable membrane 40 may comprise a laminate with a top surface layer 54, a bottom surface layer 56 and a silicone based material 58 therebetween. The sealable membrane 40 may comprise a material having a Shore hardness of between about 10 and about 100 on the Shore A durometer scale. By way of example and not in any limiting sense, the sealable membrane may have a thickness of about 100 microns to about 3 mm.

The storage module 10 may further comprise a storage container 60. The storage container 60 may have an interior 62 that is adapted and configured to store caps 64 of the tubes 26 in the interior 62 of the storage container. The storage container 60 may have a cap holder 66 that is releasably connectable with a cap holder lid 68. The cap holder 66 may have side walls and a bottom structure. The cap holder lid 68 may releasably connect with the cap holder 66 and define the interior 62 of the storage container 60. For instance, the cap holder lid 68 may have an internal groove 70 in a depending portion 72 of the cap holder lid. The internal groove 70 may cooperate with an outwardly protruding lip 74 of the cap holder 66 to allow the cap holder lid to be releasably connected with the cap holder. The storage container 60 may be shaped and dimensioned and otherwise adapted and configured to be arranged adjacent to and on top of the tube rack lid 30. The lid retaining latch 32 may also cooperate with the storage container 60 to maintain the storage container in position on top of the tube rack lid 30. The cap holder 66 may have a lid retainer cutout 76 on opposite ends of the storage container. The lid retaining latch 32 may fit within the cutout 76 in a manner to prevent undesirable end to end motion and side to side motion between the storage container 60 and the base 14. The interior 62 of the storage container 60 may have a plurality of seats 78 for retaining a cap 64 of a tube 26. A seat 78 may be aligned with a corresponding tube 26 so the cap 64 associated with the tube may be easily located.

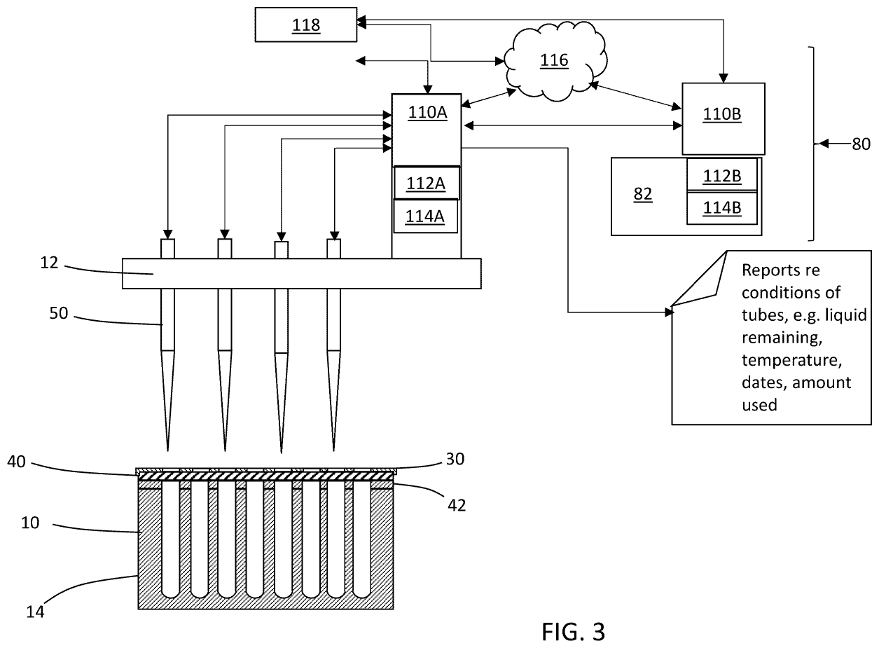

Making reference to FIG. 3, a control 80 of the liquid handler 12 and/or of the laboratory 82 may be configured to generate reports related to the storage module 10 and the tubes 26 stored therein. The reports may include liquid levels in the respective tubes 26, temperatures of the liquid in the tube, inlet and outlet temperatures of the temperature control media or fluid, tube cycle times, tube access dates and times, tube history, and remaining fluid levels in the tubes.

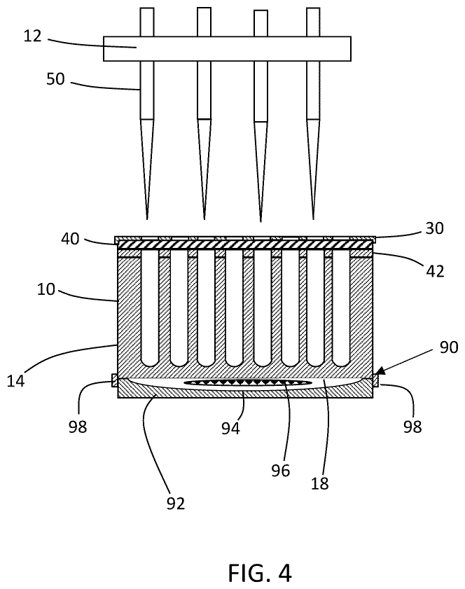

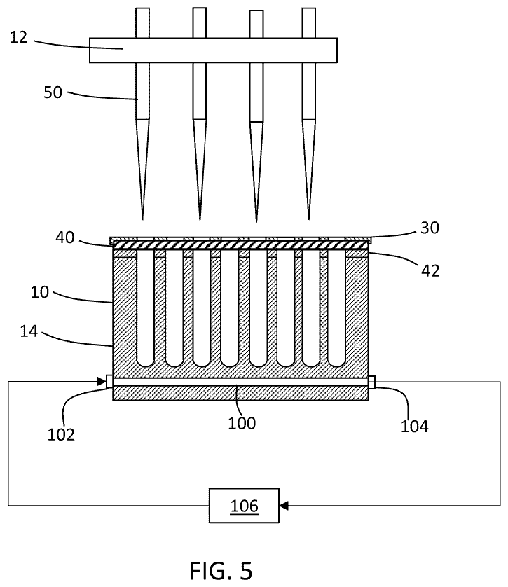

Making reference to FIGS. 4 and 5, the storage module 10 may be configured with a temperature control system 90. In one aspect as shown in FIG. 4, the base 14 may be provided with a subplate 92 that may be moved relative to the bottom 18 of the base 14 to provide access to a chamber 94 formed at the base 14 between the bottom 18 of the base and the subplate 92. The chamber 94 may be adapted and configured to receive a temperature control medium 96, for instance, a thermal pack, for controlling the temperature of the storage module 10 and the tubes 26. The thermal pack 96 may provide a temperature that is higher or lower than the ambient temperature of the liquid handler 12 as may be desired by the application. The subplate 92 and/or base 14 may have a recess that forms the chamber 94. The subplate 92 may have a releasable hinge connection 98 or be hingedly or otherwise releasably connected to the bottom 18 of the base 14 to allow access to the chamber 94.

In another aspect as shown in FIG. 5, the base 14 may be provided with one or more channels 100 that are adapted and configured for a flow of a fluid therethrough. The fluid may be a liquid or a gas, and may have a temperature that is higher elevated or lower than the ambient temperature of the liquid handler 12 as may be desired by the application. The channel(s) 100 may be coupled to a supply 102 and discharge 104 associated with a fluid source 106 with external connections, for instance, unions, pipe nipples, valves, and/or quick disconnects. The channel 100 may be formed as a circuitous flow path in the base 14 or several channels connected with a supply manifold and a discharge manifold, each of which may have the external connections 102,104 to the fluid source 106.

In use, one may access the storage module 10 for the liquid handler 12. The storage module 10 may comprise the base 14 with the top 16 and the bottom 18 and the vertical side walls 20 extending between the top and bottom as discussed above. The base 14 may further have the tube rack 22 as discussed above. A tube 26 may then be installed in the tube rack 22 of the base by inserting the tube in the rack opening 24 at the top 16 of the base in a manner such that the tube rack supports 22 the tube 26 in an upright configuration with an open end of the tube projecting from the rack opening 24 at the top 16 of the base 24. One may then access a sealable membrane 40 of the type previously discussed. One may position the sealable membrane 40 over the open end of the tube 26. Depending upon the configuration of the base 14, before positioning the sealable membrane 40 over the open end of the tube 26, one may position a retainer 42 of the type discussed above adjacent the top 16 of the base 14 and align the retainer openings 44 of the retainer 42 in register with the rack openings 24 and with the open ends of the tubes 26 projecting from the retainer opening 44. One may then position a tube rack lid 30 over the sealable membrane 40 and align lid openings 34 of the tube rack 30 in register with the rack openings 24 of the tube rack support 22.

One may then apply the sealable membrane 40 against the open end of the tube 26 by releasably connecting the tube rack lid 30 to the base 14. The step of applying the sealable membrane 40 against the open end of the tube 26 by releasably connecting the tube rack lid 30 to the base 14 may include also applying the sealable membrane on the sides of the tube adjacent the open end tube, that is, stretching the sealable membrane in a manner to engage threading or serrations 48 around the open end of the tube 26. As discussed above, the sealable membrane 40 may: (i) be comprised of a silicone based material, (ii) include a laminate with a top surface layer, a bottom surface layer and a silicone based material therebetween, (iii) be comprised of a material having a Shore hardness of between about 10 and about 100 on the Shore A durometer scale: (iv) comprise preformed sealable openings; (v) be sufficiently pliable and resilient to allow a pipette of the liquid handler to enter through the preformed sealable opening and into the tube through the open end of the tube, and to seal the open end of the tube when the pipette of the liquid handler is withdrawn from the preformed sealable opening; and/or (vi) be sufficiently pliable and resilient to allow a pipette of the liquid handler to pierce the sealable membrane and enter into the tube through the open end of the tube when the pipette of the liquid handler is withdrawn from the sealable membrane.

In another aspect of the method, caps 64 of the tubes 26 may be stored in an interior 62 of a storage container 60. The caps 64 of the tubes 26 may be stored in the interior 62 of the storage container by placing the caps 64 on seats 78, where each seat 78 is aligned with the of tubes 26 of the tube rack 22. One may place the storage container 60 adjacent to the tube rack lid 30. One may also regulate the temperature of the storage module 10 by controlling at least one of a rate of flow and a temperature of a fluid flowing through a channel 100 of the base 14, and/or by inserting a temperature control medium 96 in a chamber 94 formed at the base.

In another aspect, a control 80 for the laboratory and/or liquid handler may be provided. The control 80 may include a controller 110A,110B with a processor and memory 112A,114A,112B,114B which may execute a computer program allowing the user the ability to associate data with a storage module described above and/or each individual tube stored in the storage module described above. The control 80 may include a controller 110A that is integral with the liquid handler 12, a control system 110B of the laboratory 82 or a network 116 in communication with the liquid handler controller 110A and/or laboratory control 110B. A user interface 118 may be provided to interface with the controller 110A of the liquid handler locally at the liquid handler 12, the control 110B of the laboratory facility 82 and/or the network 116 in communication with the liquid handler controller 110A and/or laboratory control 110B. The processor and the memory 112A,112B,114A,114B may be resident locally at the liquid handler 12, computer systems associated with the laboratory 82, or distributed via the network 116, including a cloud based system. The memory 114A,114B may include a database configured to store data structures that are associated together. The processor may executed instructions to allow the user to create, store and delete a plurality of definitions associated with storage modules 10 as described above. For instance, the computer program may allow the user to: (i) record the placement of particular reagent tubes in each storge module, (ii) name each reagent tube in the storage module, including associating a volume, a contents description, and/or an expiration date of each reagent placed inside a particular reagent tube of each storage module; (iii) create, store and delete a plurality of reagent mix definitions referencing the reagents previously defined within the storage module definitions; and/or (iv) upon user request, produce a list of commands to the liquid handler to cause the liquid handler to draw the reagents out of a plurality of storage modules and mix them in a sequence and proportions specified in the reagent mix definition.

Further embodiments can be envisioned by one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, various modifications and changes may be made thereunto without departing from the broader spirit and scope of the invention as set forth in the claims and that the invention is intended to cover all modifications and equivalents within the scope of the following claims.

What is claimed is:

1. A storage module for a liquid handler, the storage module comprising:
a base adapted and configured to be releasably mounted to the liquid handler, the base having a top and a bottom and vertical side walls extending between the top and bottom, the base having a tube rack, the tube rack comprising a plurality of rack openings extending through the top of the base, the tube rack being adapted and configured to support a plurality of tubes in an upright configuration with open ends of the tubes projecting from the rack openings of the top of the base;
a tube rack lid, the tube rack lid being releasably connectable to the base, the tube rack lid having lid openings in register with the rack openings when the tube rack lid is releasably connected with the base; and
a sealable membrane adapted and configured to be disposed between the top of the base and the tube rack lid, the sealable membrane being adapted and configured to seal an open end of at least one tube when the at least one tube is received in the tube rack.

2. The storage module of claim 1 further comprising a retainer, the retainer being adapted and configured to be disposed between the sealable membrane and the top of the base, the retainer having retainer openings in register with the rack openings and in register with the lid openings when the tube rack lid is releasably connected with the base and the retainer is positioned adjacent the top of the base.

3. The storage module of claim 1 wherein the sealable membrane is configured to engage around sides of the at least one tube adjacent the open end of the at least one tube when the at least one tube is received in the tube rack.

4. The storage module of claim 1 wherein the sealable membrane comprises a silicone based material having a Shore hardness of between about 10 and about 100 on the Shore A durometer scale.

5. The storage module of claim 1 wherein the sealable membrane has a preformed sealable opening, the sealable membrane comprises a material sufficient to allow a pipette of the liquid handler to enter through the preformed sealable opening and into the at least one tube through the open end of the at least one tube when the at least one tube is received in the tube, and to seal the open end of the at least one tube when the pipette of the liquid handler is withdrawn from the preformed sealable opening.

6. The storage module of claim 1 wherein the sealable membrane comprises a material sufficient to allow a pipette of the liquid handler to pierce the sealable membrane and enter into the at least one tube through the open end of the at least one tube when the at least one tube is received in the tube, and seal the open end of the at least one tube when the pipette of the liquid handler is withdrawn from the sealable membrane.

7. The storage module of claim 1 further comprising a storage container, the storage container having an interior, the interior being adapted and configured to store caps of the tubes in the interior.

8. The storage module of claim 7 wherein the storage container has a cap holder releasably connectable with a cap holder lid, the cap holder and the cap holder lid defining the interior.

9. The storage module of claim 7 wherein the storage container is adapted and configured to be arranged adjacent to the tube rack lid.

10. The storage module of claim 7 wherein the storage container has a plurality of seats that are aligned with the plurality of tubes in the tube rack, each seat is adapted and configured to receive a cap of the at least one tube.

11. The storage module of claim 1 wherein the base has one of (i) a channel adapted and configured for a flow of a fluid therethrough, and (ii) a chamber adapted and configured to receive a temperature control medium therein.

12. A sealable membrane for a storage module of a liquid handler, the sealable member being adapted and configured to seal open ends of a plurality of tubes received in a tube rack of a base of the storage module, the sealable membrane being adapted and configured to be disposed between a top of the base and a tube rack lid of the storage module in a manner to seal an open end of at least one tube when the at least one tube is received in the tube rack of the base.

13. The sealable membrane of claim 12 wherein the sealable membrane is configured to engage around sides of the at least one tube adjacent the open end of the at least one tube when the at least one tube is received in tube rack.

14. A method comprising:
accessing a storage module for a liquid handler wherein the storage module comprises a base having a top and a bottom and vertical side walls extending between the top and bottom, the base has a tube rack;
installing a tube in a tube rack of the base by inserting the tube in a rack opening that extends through the top of the base in a manner such that the tube rack supports the tube in an upright configuration with an open end of the tube projecting from the rack opening of the top of the base;
accessing a sealable membrane;
positioning the sealable membrane over the open end of the tube;
positioning a tube rack lid over the sealable membrane and aligning lid openings of the tube rack in register with the rack openings; and
applying the sealable membrane against the open end of the tube by releasably connecting the tube rack lid to the base.

15. The method of claim 14 further comprising:
before positioning a sealable membrane over the open end of the tube, positioning a retainer adjacent the top of the base and aligning retainer openings of the retainer in register with the rack openings with the open end of the tube projecting from the retainer opening.

16. The method of claim 14 wherein the step of applying the sealable membrane against the open end of the tube by releasably connecting the tube rack lid to the base includes applying the sealable membrane on the sides of the tube adjacent the open end tube.

17. The method of claim 14 further comprising:
storing caps of the tubes in an interior of a storage container by placing the caps on seats, wherein each seat is aligned with a corresponding tube of the tube rack; and
positioning the storage container adjacent to the tube rack lid.

18. The method of claim 14 further comprising regulating the temperature of the storage module by one of (i) controlling at least one of a rate of flow and a temperature of a fluid flowing through a channel of the base, and (ii) inserting a temperature control medium in a chamber of the base.

19. A liquid handler comprising:
a storage module comprising:
a base, the base being adapted and configured to be releasably mounted to the liquid handler, the base having a top and a bottom and vertical side walls extending between the top and bottom, the base having a tube rack, the tube rack comprising a plurality of rack openings extending through the top of the base, the tube rack being adapted and configured to support a plurality of tubes in an upright configuration with open ends of the tubes projecting from the rack openings of the top of the base;
a tube rack lid, the tube rack lid being releasably connectable to the base, the tube rack lid having lid openings in register with the rack openings when the tube rack lid is releasably connected with the base; and
a sealable membrane adapted and configured to be disposed between the top of the base and the tube rack lid, the sealable membrane being adapted and configured to seal an open end of at least one tube when the at least one tube is received in tube rack; and
pipettes adapted and configured to penetrate through the sealable membrane to access fluid in the at least one tube.

20. The liquid handler of claim 19 further comprising a controller, the controller being adapted and configured to generate signals for controlling the liquid handler, the controller comprising a user interface, a processor, and a memory, the processor and memory being configured to associated a plurality of data structures together, the data structures including data representative of at least one of the following: (i) a characteristic of a particular storage module, (ii) a location of a tube in a particular storage module; (iii) a name of a tube in a particular storage module; (iv) a volume of a tube in a particular storage unit; (v) a contents description of a tube in a particular storage module; (vi) an expiration date of a reagent placed inside a tube in a particular storage module; and/or (vii) a mix definition for one or more reagents to be placed in a tube of a particular storage module.

21. The liquid handler of claim 20, wherein the controller is adapted and configured to generate signals that enable the liquid handler to draw one or more reagents from one or more tubes of a storage module, and mix the reagents in a sequence and in a proportion specified in the reagent mix definition.
